(19) United States
(12) Patent Application Publication
(10) Pub. No.: US 2006/0242891 A1
(43) Pub. Date: Nov. 2, 2006

(54) Container

(76) Inventor: Christopher Marshall, Ramona, CA (US)

Correspondence Address: Mark H. Snyder, Esq., Number 23, 5020 Codorniz Way, Oceanside, CA, 92057, US

(21) Appl. No.: 11/118,874

(22) Filed: Apr. 29, 2005

(51) Int. Cl. A01M 1/20

(52) U.S. Cl. 43/131; 43/132.1

(57) ABSTRACT

The present invention relates to containers that include features for killing, repelling or trapping insects attracted to the contents of the container.

### BACKGROUND OF THE INVENTION

Human and animal food, or waste, such as household garbage, that are kept in containers often attract insects. These insects include, but are not limited to ants, flies, and roaches. The insects can transport harmful bacteria or viruses, thus spreading disease to both humans and domesticated animals, such as cats and dogs.

Most containers are designed for the purpose of confining or accumulating materials for storage and later use or disposal. Some containers include enclosures to control access to the materials stored or accumulated therein. These enclosures can also have the benefit of creating a physical barrier to insects that may be attracted to the contents of the container. The effectiveness of enclosures as a means to control access by insects to the contents of a container can be reduced when constant, or repeated access to the container is required. For example, a household trash can must be repeatedly accessed for the purposes of accumulating trash for later disposal. In other cases, the enclosure may not be capable of functioning as a physical barrier to all types of insects that may be attracted. Some very small insects, such as ants, may be able to access a container's contents through very minute openings in an enclosure. An enclosure for some types of containers, such as pet food or drink containers, may not be practical if the container must be open to the air for continual access by a pet.

Accordingly, there is a need for containers that impede or prevent insects from accessing the contents of the container while not impeding such access by humans and/or animals.

### BRIEF DESCRIPTION OF THE DRAWINGS

FIG. 1 is a cross-sectional view of a container of the present invention.

FIG. 2 is an exterior, side view of a holder for use in connection with a container of the present invention.

FIG. 3 is a cross-sectional view of a holder for use in connection with a container of the present invention.

FIG. 4 is a cross-sectional view of a container of the present invention.

### DETAILED DESCRIPTION

As described more fully below, the present invention is directed toward containers that include features for killing, repelling, or trapping insects attracted to the contents of the container.

As used herein, the term “container” means any device used to confine substances that includes at least one wall and one bottom surface. The wall of the container has at least one internal surface and at least one external surface. An internal surface of the container defines, or helps to define a confinement area for confining substances within the container. At least a portion of the internal surface comes into contact with a substance to be confined, except in the event that the container has a liner, as the case may be with waste containers. An external surface of the container is open to an environment outside the confinement area of the container.

The container wall and bottom may be constructed of nearly any material, including but not limited to plastic, metal, wood, clay, porcelain, composite and laminated materials. The construction of the wall and bottom of the container may be single or multi-walled. The containers can include a closure, such as a lid. Examples of containers include, but are not limited to waste containers, commonly referred to as trash cans, pet food bowls, and laundry bins.

The containers as described herein may also include one or more members for supporting the container, such as a stand, or feet. A supporting member may be separate from, or incorporated into the wall and/or bottom surfaces of the container. A supporting member comes into contact with another surface such as a floor, counter-top, shelf, or ground, and supports the structure of the container. A supporting member may also be designed to allow access of insects to an insecticide, trap or repellent (or allow repellent to be effective) as more fully set forth herein. A supporting member may also be designed or contain features that control or impede access to the contents of a container by insects. Solely by way of example, a supporting member may be a thin, pin-like structure that supports a pet food container. This pin-like structure may prevent larger crawling insects from accessing the contents of the container because the physiology of the insects restricts them from crawling up the supporting member. Alternatively, the thin, pin-like structure may prevent large numbers of smaller crawling insects from accessing the contents of the container simultaneously. A supporting member may also be designed to direct the path of travel for a crawling insect that may attempt to access the containment area of the container.

The containers also include features for killing, repelling, or trapping insects attracted to the contents of the container. Such features include a holder for connecting an insecticide, insect repellent or insect trap to the container. The holder may be connected to the container in close proximity to any external surface of the container that may be accessed by insects. Preferably, the holder is connected to the container in close proximity to the external bottom surface of the container, or to the external bottom surface of the container itself. As used herein, the phrase “connected to” refers to any method of temporarily or permanently affixing the holder to a surface of the container, and includes incorporation of the holder into a surface of the container itself. Most preferably, the holder is connected to the container within or near a pathway of travel for a crawling insect that attempts to access the contents of the container.

The holder includes an insecticide, insect repellent or insect trap as more fully described herein. Preferably, the holder includes features and/or is located on the container in a manner that makes it difficult for humans and pets to access the contents of the holder. Preferably, the contents of the holder and/or the holder itself are disposable or rechargeable and removable from the container.

The holder may contain an insecticide. Nearly any type of insecticide may be used in the holder. The insecticide may be targeted for certain types of crawling insects, such as ants or roaches, or may be broadly applicable to many different types of insects. Similarly, the insecticides may be those that kill insects on contact or those that are intended to kill insects after a significant time period following exposure. The insecticide may be combined with an insect food, bait and/or an insect attractant to make it more effective. By way of example, insecticides useful in the invention for controlling ants and other insects include, but are not limited to one or more of the following: Abamectin, Acephate, d-Allethrin, 4-tert-Amylphenol, Aromatic petroleum solvent, Arsenous acid anhydride, Azadirachtin, 2-Benzyl-4-chlorophenol, Bifenthrin, Borax, Boric acid, Boron sodium oxide, Butoxypolypropylene, Carbaryl, Chloropicrin, Chlorpyrifos, Cinnamaldehyde, Copper hydroxide, Copper naphthenate, Copper(II) oxide, (R+S)-alpha-Cyano-3-phenoxybenzyl (1S+1R)-cis-3-(Z-2-chloro-3, Cyfluthrin, Cypermethrin, Deltamethrin, Diazinon, Dichlorvos, Didecyl dimethyl ammonium chloride, Dihydro-5-pentyl-2(3H)-furanone, Esfenvalerate, Ethofenprox, Fenoxycarb, Fenvalerate, Fipronil, Fluvalinate, Garlic oil, 5-Heptyldihydro-2(3H)-furanone, Hydramethylnon, Imidacloprid, Imiprothrin, Isopropanol, Limonene, Linalool, Malathion, Metaldehyde, S-Methoprene, Methyl bromide, 2-(1-Methyl-2-(4-phenoxyphenoxy)ethoxy)pyridine, Myclobutanil, N-Octyl bicycloheptene dicarboximide, Permethrin, Phenothrin, 2-Phenylethyl propionate, o-Phenylphenol, Piperonyl butoxide, Prallethrin, Propetamphos, Propoxur, Pyrethrins, Resmethrin, Rotenone, Silica gel, Silicon dioxide, Sodium hypochlorite, Sulfluramid, Tetramethrin, Tralomethrin, Trifluralin, Xylene, Zinc naphthenate and beta-cyfluthrin.

The holder may contain an insect repellant. Insect repellants include, but are not limited to chemical and electronic insect repellents. Electronic insect repellants include sound emitting devices, such as ultrasonic or vibrational devices.

The holder may contain an insect trap. The insect trap is designed to trap and contain insects that enter the trap. To trap the insects, the interior of the holder may include a sticky substance that adheres to the insect and prevents it from exiting the trap. To make the trap more effective, it may also contain an insect attractant, such as an insect food, bait or other chemical attractant.

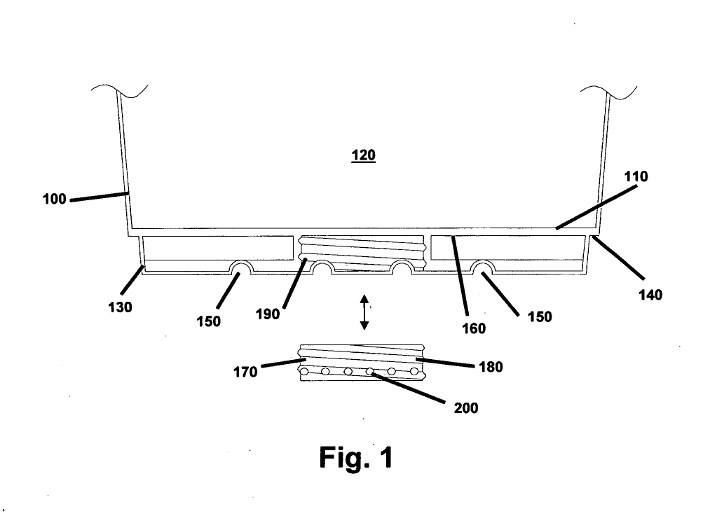

With reference to FIG. 1, a generally cylindrical container, such as a trash container, is shown in cross-sectional view. The container is comprised of a wall 100, and a bottom surface 110, which define a containment area 120 to confine substances, such as liquids, foods, or trash. In the case that the container is a trash can, containment area may also contain a plastic trash liner and/or a lid (not shown). Supporting member 130, in the form of a walled ridge extending from the exterior bottom surface 140 supports the container when it is placed on a surface, such as a floor. Supporting member includes openings 150 that are designed to allow insects to gain access to the exterior bottom surface 160 of the container that contains a removable holder 170. Removable holder can be connected to the exterior bottom surface 160 through threads 180 on the holder 170 that mate with corresponding threads 190 extending from the bottom surface 160.

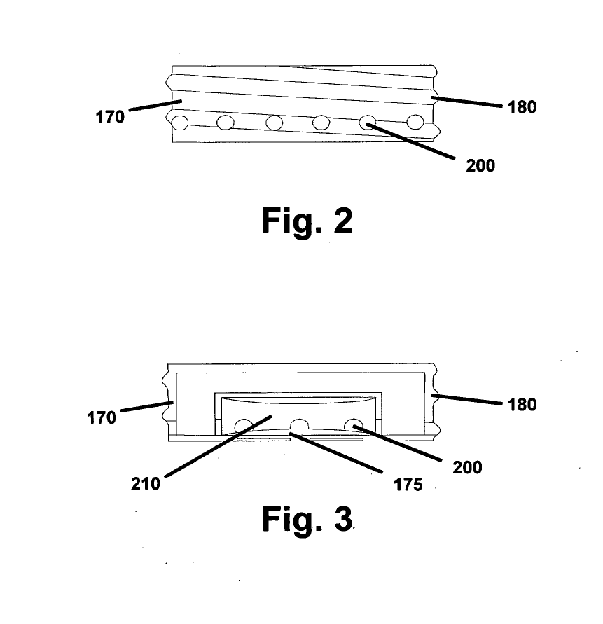

With reference to FIGS. 2 and 3, a generally cylindrical holder is shown in side (exterior) and cross-sectional views. The holder 170 includes openings 200 that are designed to allow insects to gain access to the interior 210 of holder 170. The interior 210 of holder 170 may contain an insecticide, insect repellant, insect attractant, an insect trap, or any combination thereof 175. As insects enter the holder 170 through openings 200, they come into contact with the contents 175 of the holder 170, and may be killed, repelled or trapped within the holder 170. The contents 175 of holder 170 may be rechargeable, or the holder 170 itself may be disposable once the effectiveness of the contents 175 of holder 170 has been reduced through use.

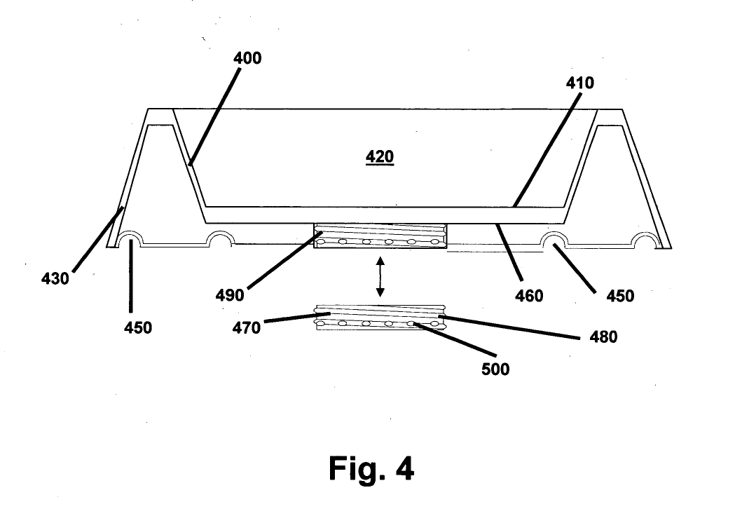

With reference to FIG. 4, a generally cylindrical container is shown in cross-sectional view. The container, in this case a pet food bowl, is comprised of a wall 400, and a bottom surface 410, which define a containment area 420 to confine substances, such as liquids, or food. Supporting member 430, in the form of an extension of an exterior surface of the wall, supports the container when it is placed on a surface, such as a floor. Supporting member includes openings 450 that are designed to allow insects to gain access to the exterior bottom surface 460 of the container that contains a removable holder 470. Removable holder can be connected to the exterior bottom surface 460 through threads 480 on the holder 470 that mate with corresponding threads 490 extending from the bottom surface 460. Holder 470 includes openings 500 that are designed to allow insects to gain access to the interior of holder 470 (as set forth previously with regard to FIGS. 2 and 3.

The foregoing description of the invention has been presented for purposes of illustration and description. Further, the description is not intended to limit the invention to the form disclosed herein. Consequently, variations and modifications commensurate with the above teachings, and the skill or knowledge in the relevant art, are within the scope of the present invention. The embodiment described hereinabove is further intended to explain modes for practicing the invention and to enable others skilled in the art to utilize the invention in various embodiments and with various modifications required by their particular applications or uses of the invention. It is intended that the appended claims be construed to include alternate embodiments to the extent permitted by the prior art.

What is claimed is:

1. A container comprising:
a containment area defined by at least one wall and a bottom surface, said wall and said bottom surface each having interior and exterior surfaces;
an insecticide holder in close proximity to the exterior bottom surface of said containment area and connected to an exterior surface, said insecticide holder comprising an insecticide, an insect attractant, and an insect trap.

2. The container as claimed in claim 1, wherein said container is a container for food.

3. The container as claimed in claim 1, wherein said container is a container for waste.

4. The container as claimed in claim 1, wherein said insecticide is an insecticide for ants.

5. The container as claimed in claim 1, wherein said insecticide is selected from the group consisting of Abamectin, Acephate, d-Allethrin, 4-tert-Amylphenol, Aromatic petroleum solvent, Arsenous acid anhydride, Azadirachtin, 2-Benzyl-4-chlorophenol, Bifenthrin, Borax, Boric acid, Boron sodium oxide, Butoxypolypropylene, Carbaryl, Chloropicrin, Chlorpyrifos, Cinnamaldehyde, Copper hydroxide, Copper naphthenate, Copper(II) oxide, (R+S)-alpha-Cyano-3-phenoxybenzyl (1S+1R)-cis-3-(Z-2-chloro-3, Cyfluthrin, Cypermethrin, Deltamethrin, Diazinon, Dichlorvos, Didecyl dimethyl ammonium chloride, Dihydro-5-pentyl-2(3H)-furanone, Esfenvalerate, Ethofenprox, Fenoxycarb, Fenvalerate, Fipronil, Fluvalinate, Garlic oil, 5-Heptyldihydro-2(3H)-furanone, Hydramethylnon, Imidacloprid, Imiprothrin, Isopropanol, Limonene, Linalool, Malathion, Metaldehyde, S-Methoprene, Methyl bromide, 2-(1-Methyl-2-(4-phenoxyphenoxy)ethoxy)pyridine, Myclobutanil, N-Octyl bicycloheptene dicarboximide, Permethrin, Phenothrin, 2-Phenylethyl propionate, o-Phenylphenol, Piperonyl butoxide, Prallethrin, Propetamphos, Propoxur, Pyrethrins, Resmethrin, Rotenone, Silica gel, Silicon dioxide, Sodium hypochlorite, Sulfluramid, Tetramethrin, Tralomethrin, Trifluralin, Xylene, Zinc naphthenate and beta-cyfluthrin.

6-10. (canceled)

11. A container comprising:
a containment area defined by at least one wall and a bottom surface, said wall and said bottom surface each having interior and exterior surfaces;
an insect trap in close proximity to the exterior bottom surface of said containment area and connected to an exterior surface, said insect trap comprising an insect attractant.

12. The container as claimed in claim 11, wherein said container is a container for food.

13. The container as claimed in claim 11, wherein said container is a container for waste.

14. The container as claimed in claim 11, wherein said insect trap is targeted to capture ants.

15. The container as claimed in claim 11, wherein said insect trap is targeted to attract and capture ants.
